(19) United States
(12) Patent Application Publication
(10) Pub. No.: US 2023/0065117 A1
(43) Pub. Date: Mar. 2, 2023

(54) MUSIC RECORDING AND COLLABORATION PLATFORM

(71) Applicant: SPOUT SOFTWARE INC., AUSTIN, TX (US)

(72) Inventors: Bruce Gardner, Austin, TX (US); Jerry ORTA, Pflugerville, TX (US)

(73) Assignee: SPOUT SOFTWARE INC., AUSTIN, TX (US)

(21) Appl. No.: 17/896,867

(22) Filed: Aug. 26, 2022

Related U.S. Application Data
(60) Provisional application No. 63/238,000, filed on Aug. 27, 2021.

(51) Int. Cl. G10H 1/00; G06F 16/683

(52) U.S. Cl. CPC G10H 1/0058; G10H 1/0008; G06F 16/683

(57) ABSTRACT

Methods, systems and non-transitory computer-readable mediums for remote audio project collaboration. The method includes generating a first version of an audio project file including a reference track. The method also includes receiving a first audio track from a first user computing device. The first audio track is synced to the reference track. The method further includes generating a second version of the audio project file by adding the first audio track to the audio project file. The method also includes receiving a second audio track from a second user computing device. The second audio track is synced to the reference track. The second user computing device is remotely located from the first user computing device. The method further includes generating a third version of the audio project file by adding the second audio track to the audio project file.

### CROSS-REFERENCE TO RELATED APPLICATIONS

This application claims priority to and the benefit of U.S. Provisional Application Ser. No. 63/238,000, filed Aug. 27, 2021, titled “MUSIC RECORDING AND COLLABORATION PLATFORM,” the entire disclosure of which is hereby incorporated by reference.

### BACKGROUND

Many audio collaborations are between geographically distributed audio creators. In such collaborations, shareable editing of audio tracks from geographically distributed providers is used to produce a single audio project file. The current options for remote audio collaborations are limited. Some audio creators use a sharing model such as a cloud static file sharing service to manually share audio files separate from the Digital Audio Workstation (DAW) the user utilizes to create music. However, this model is time-consuming and requires additional oversight to ensure each audio creator is working with the latest version of each audio track. Other audio creators use a software-specific model in which everyone has to have the same software. However, this model requires the purchase of often expensive software tools and prohibits each audio creator from using their preferred audio software.

### SUMMARY

In addition to the technical challenges described above, synchronizing audio tracks from different audio creators presents many technical challenges. For example, each audio creator's recording system exhibits a specific system latency that can change over time. Further, the limitations of current remote communication technology prohibits geographically distributed audio creators from conducting jam sessions in perfect sync. Accordingly, the present disclosure provides methods and systems for remote audio project collaboration that, among other things, send and receive digital assets between audio creators in near real-time, account for unique system latencies, and provide a reference track for audio creators to sync their music to.

The present disclosure provides a method for remote audio project collaboration. The method includes generating a first version of an audio project file. The first version of the audio project file includes a reference track. The method also includes sending the first version of the audio project file to a plurality of user computing devices. The method further includes receiving a first audio track from a first user computing device included in the plurality of user computing devices. The first audio track is synced to the reference track. The method also includes generating a second version of the audio project file by adding the first audio track to the first version of the audio project file. The method further includes sending the second version of the audio project file to the plurality of computing devices. The method also includes receiving a second audio track from a second user computing device included in the plurality of user computing devices. The second audio track is synced to the reference track. The second user computing device is remotely located from the first user computing device. The method further includes generating a third version of the audio project file by adding the second audio track to the second version of the audio project file. The method includes sending the third version of the audio project file to the plurality of computing devices.

The present disclosure also provides a system for remote audio project collaboration including, in one implementation, a plurality of user computing devices and a server. The plurality of user computing devices includes at least a first user computer device and a second user computing device. The second user computing device is remotely located from the first user computing device. The server is configured to generate a first version of an audio project file. The first version of the audio project file includes a reference track. The server is also configured to send the first version of the audio project file to the plurality of user computing devices. The server is further configured to receive a first audio track from the first user computing device. The first audio track is synced to the reference track. The server is also configured to generate a second version of the audio project file by adding the first audio track to the first version of the audio project file. The server is further configured to send the second version of the audio project file to the plurality of user computing devices. The server is also configured to receive a second audio track from the second user computing device. The second audio track is synced to the reference track. The server is further configured to generate a third version of the audio project file by adding the second audio track to the second version of the audio project file. The server is also configured to send the third version of the audio project file to the plurality of user computing devices.

The present disclosure also provides a tangible, non-transitory computer-readable medium storing instructions that, when executed, cause a processing device to generate a first version of an audio project file. The first version of the audio project file includes a reference track. The instructions also cause the processing device to send the first version of the audio project file to a plurality of user computing devices. The instructions further cause the processing device to receive a first audio track from a first user computing device included in the plurality of user computing devices. The first audio track is synced to the reference track. The instructions also cause the processing device to generate a second version of the audio project file by adding the first audio track to the first version of the audio project file. The instructions further cause the processing device to send the second version of the audio project file to the plurality of user computing devices. The instructions also cause the processing device to receive a second audio track from a second user computing device included in the plurality of user computing devices. The second audio track is synced to the reference track. The second user computing device is remotely located from the first user computing device. The instructions further cause the processing device to generate a third version of the audio project file by adding the second audio track to the second version of the audio project file. The instructions also cause the processing device to send the third version of the audio project file to the plurality of user computing devices.

The present disclosure also provides a central storage, a recording console, an import/export digital assets feature, audio mix capabilities within one platform, to facilitate the recording and sharing of audio tracks quickly. Further, the disclosed platform provides a software agnostic tool where users can collaborate but still use other Digital Audio Workstation (DAW) applications. The disclosed software installed on a user's computing device provides IoT capabilities by transmitting/receiving data and uploading/downloading digital assets in real-time. The disclosed platform and internet-connected devices facilitate live audio/video file synchronization, chat messages, video conferencing, and text translation across devices. Software on the user computing devices and platform provides audio/video recording and playback, audio manipulation, audio generation, and audio mix capabilities. The disclosed software can export/import digital assets to third-party applications for further enhancements. The disclosed device software and platform enable recording audio/video at high quality from remote users combined with near real-time collaboration through text messaging and video conferencing.

Other technical features may be readily apparent to one skilled in the art from the following figures, descriptions, and claims.

### BRIEF DESCRIPTION OF THE DRAWINGS

For a more complete understanding of the present disclosure and its advantages, reference is now made to the following description, taken in conjunction with the accompanying drawings. It is emphasized that, according to common practice, the various features of the drawings are not necessarily to-scale. On the contrary, the dimensions of the various features may be—and typically are—arbitrarily expanded or reduced for the purpose of clarity.

FIG. 1 is a block diagram of an example of a system for remote audio project collaboration, in accordance with some implementations of the present disclosure.

FIG. 2 is a block diagram of an example of a computer system, in accordance with some implementations of the present disclosure.

FIG. 3 is a flow diagram of an example of a method for remote audio project collaboration, in accordance with some implementations of the present disclosure.

FIG. 4A is a screen shot of an example of a graphical user interface (GUI) for editing an audio project file, in accordance with some implementations of the present disclosure.

FIG. 4B is a screen shot of an example of the GUI of FIG. 4A after a first audio track is added to the audio project file.

FIG. 4C is a screen shot of an example of the GUI of FIG. 4B after a second audio track is added to the audio project file.

FIG. 5 is a screen shot of an example of a GUI for performing a latency test, in accordance with some implementations of the present disclosure.

FIG. 6 is a screen shot of an example of the GUI of FIG. 5 after a latency test has been performed.

FIG. 7 is a screen shot of an example of a chat feature included in a GUI for editing an audio project file, in accordance with some implementations of the present disclosure.

### NOTATION AND NOMENCLATURE

Various terms are used to refer to particular system components. A particular component may be referred to commercially or otherwise by different names. Further, a particular component (or the same or similar component) may be referred to commercially or otherwise by different names. Consistent with this, nothing in the present disclosure shall be deemed to distinguish between components that differ only in name but not in function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices and connections.

The terminology used herein is for the purpose of describing particular example implementations only, and is not intended to be limiting. As used herein, the singular forms “a,” “an,” and “the” may be intended to include the plural forms as well, unless the context clearly indicates otherwise. The method steps, processes, and operations described herein are not to be construed as necessarily requiring their performance in the particular order discussed or illustrated, unless specifically identified as an order of performance. It is also to be understood that additional or alternative steps may be employed.

The terms first, second, third, etc. may be used herein to describe various elements, components, regions, layers and/or sections; however, these elements, components, regions, layers and/or sections should not be limited by these terms. These terms may be only used to distinguish one element, component, region, layer, or section from another region, layer, or section. Terms such as “first,” “second,” and other numerical terms, when used herein, do not imply a sequence or order unless clearly indicated by the context. Thus, a first element, component, region, layer, or section discussed below could be termed a second element, component, region, layer, or section without departing from the teachings of the example implementations. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. In another example, the phrase “one or more” when used with a list of items means there may be one item or any suitable number of items exceeding one.

Spatially relative terms, such as “inner,” “outer,” “beneath,” “below,” “lower,” “above,” “up,” “upper,” “top,” “bottom,” “down,” “inside,” “outside,” “contained within,” “superimposing upon,” and the like, may be used herein. These spatially relative terms can be used for ease of description to describe one element's or feature's relationship to another element(s) or feature(s) as illustrated in the figures. The spatially relative terms may also be intended to encompass different orientations of the device in use, or operation, in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

“Real-time” may refer to less than or equal to 2 seconds. “Near real-time” may refer to any interaction of a sufficiently short time to enable two individuals to engage in a dialogue via such user interface, and will generally be less than 10 seconds (or any suitable proximate difference between two different times) but greater than 2 seconds.

The term “remotely located” as used herein in relation to computing devices may refer to any amount of distance between computing devices that prohibits a user of one computing device from hearing audio generated by or proximate to a computing device of another user.

The term “version” may used herein to describe audio project files; however, audio project files should not be limited by this term. The term “version” may only be used to distinguish a single audio project file before and after a change has been made. The use of the term “version” is not intended to imply to use of version control (i.e., the practice of tracking and managing changes to software code).

### DETAILED DESCRIPTION

The following discussion is directed to various implementations of the present disclosure. Although one or more of these implementations may be preferred, the implementations disclosed should not be interpreted, or otherwise used, as limiting the scope of the present disclosure, including the claims. In addition, one skilled in the art will understand that the following description has broad application, and the discussion of any implementation is meant only to be exemplary of that implementation, and not intended to intimate that the scope of the disclosure, including the claims, is limited to that implementation.

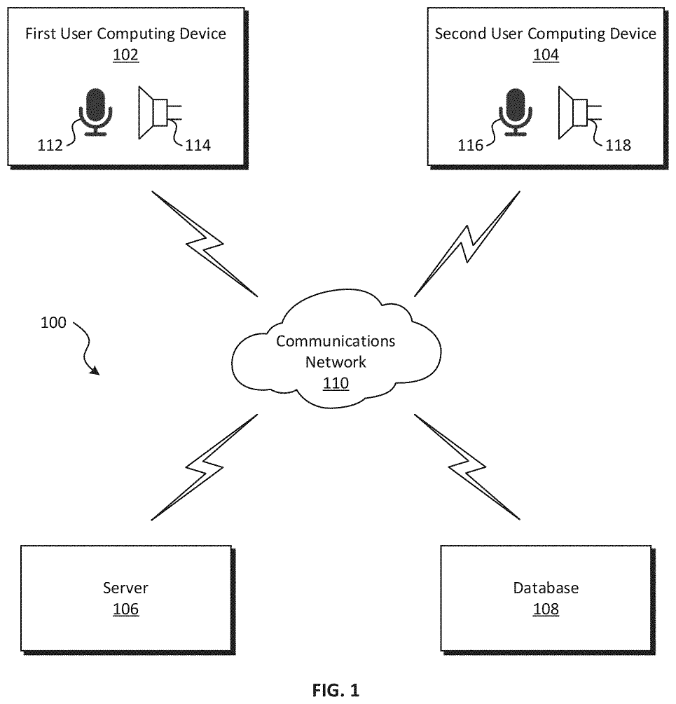

FIG. 1 is a block diagram of an example of a system 100 for remote audio project collaboration. The system 100 illustrated in FIG. 1 includes a plurality of user computing devices (in particular, a first user computing device 102 and a second user computing device 104), a server 106, a database 108, and a communications network 110. The system 100 may include fewer, additional, or different components in different configurations than the system 100 illustrated in FIG. 1. For example, in some implementations, the plurality of user computing devices may include more than two user computing devices.

User computing devices may include, for example, a smartphone, a tablet, a laptop computer, a desktop computer, or a combination thereof. The first user computing device 102 illustrated in FIG. 1 includes a microphone 112 and a speaker 114. Similarly, the second user computing device 104 illustrated in FIG. 1 also includes a microphone 116 and a speaker 118. Naturally, user computing devices may include additional components that are not shown or described in detail. For example, user computing devices may include other components such as a Musical Instrument Digital Interface (MIDI) device. The second user computing device 104 is remotely located from the first user computing device 102. In other words, the first user computing device 102 and the second user computing device 104 are positioned far apart from each other such that the users of the two devices cannot play music together in real-time. For example, the first user computing device 102 and the second user computing device 104 could be located in different buildings, towns, states, or countries.

The communications network 110 may be a wired network, a wireless network, or both. All or parts of the communications network 110 may be implemented using various networks, for example, a cellular network, the Internet, a Bluetooth™ network, a wireless local area network (for example, Wi-Fi), a wireless accessory Personal Area Networks (PAN), cable, an Ethernet network, satellite, a machine-to-machine (M2M) autonomous network, and a public switched telephone network. The first user computing device 102, the second user computing device 104, the server 106, and other various components of the system 100 communicate with each other over the communications network 110 using suitable wireless or wired communication protocols. In some implementations, communications with other external devices (not shown) occur over the communications network 110. In some implementations, the communications network 110 include one or more live websocket connections.

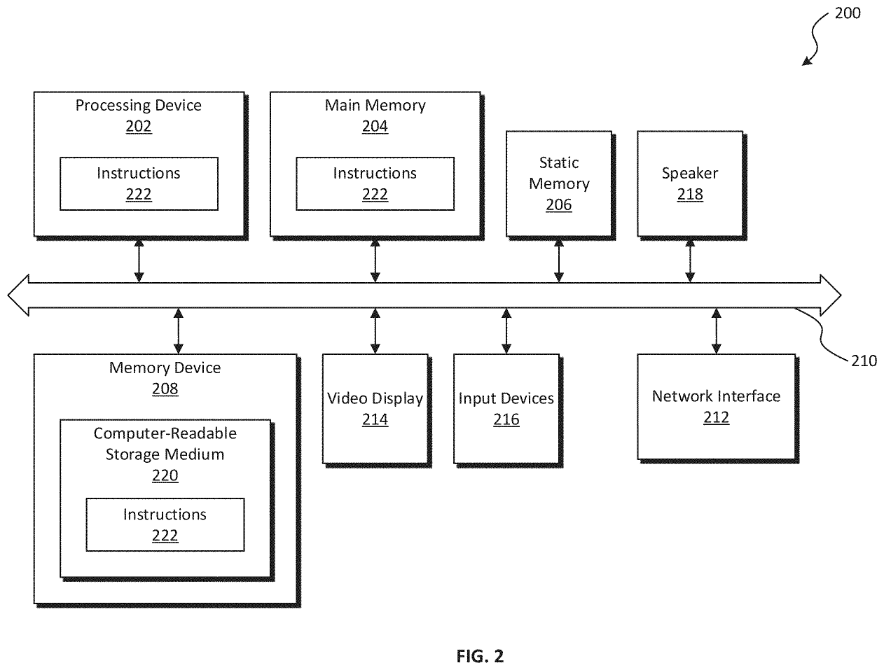

FIG. 2 is a block diagram of an example of a computer system 200. The computer system 200 may be connected (e.g., networked) to other computer systems in a LAN, an intranet, an extranet, or the Internet, including via the cloud or a peer-to-peer network. The computer system 200 may operate in the capacity of the first user computing device 102, the second user computing device 104, the server 106, and/or the database 108 of the system 100 illustrated in FIG. 1. The computer system 200 may be a personal computer (PC), a tablet computer, a wearable (e.g., wristband), a set-top box (STB), a personal Digital Assistant (PDA), a mobile phone, a smartphone, a camera, a video camera, an Internet of Things (IoT) device, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The computer system 200 illustrated in FIG. 2 includes a processing device 202, a main memory 204 (e.g., read-only memory (ROM), flash memory, solid state drives (SSDs), dynamic random access memory (DRAM) such as synchronous DRAM (SDRAM)), a static memory 206 (e.g., flash memory, solid state drives (SSDs), static random access memory (SRAM)), and a memory device 208, which communicate with each other via a bus 210.

The processing device 202 represents one or more general-purpose processing devices such as a microprocessor, central processing unit, or the like. More particularly, the processing device 202 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 202 may also be one or more special-purpose processing devices such as an application specific integrated circuit (ASIC), a system on a chip, a field programmable gate array (FPGA), a digital signal processor (DSP), network processor, or the like. The processing device 202 may be configured to execute instructions for performing any of the operations and steps discussed herein.

The computer system 200 illustrated in FIG. 2 further includes a network interface device 212. The computer system 200 also may include a video display 214 (e.g., a liquid crystal display (LCD), a light-emitting diode (LED), an organic light-emitting diode (OLED), a quantum LED, a cathode ray tube (CRT), a shadow mask CRT, an aperture grille CRT, a monochrome CRT), input devices 216 (e.g., a keyboard and/or a mouse or a gaming-like control), and one or more speakers 218 (e.g., a speaker). In one illustrative example, the video display 214 and the input devices 216 may be combined into a single component or device (e.g., an LCD touch screen).

The memory device 208 may include a computer-readable storage medium 220 on which the instructions 222 embodying any one or more of the methods, operations, or functions described herein is stored. The instructions 222 may also reside, completely or at least partially, within the main memory 204 and/or within the processing device 202 during execution thereof by the computer system 200. As such, the main memory 204 and the processing device 202 also constitute computer-readable media. The instructions 222 may further be transmitted or received over a network via the network interface device 212.

While the computer-readable storage medium 220 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium capable of storing, encoding or carrying out a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The methods described herein may be performed by processing logic that may include hardware (circuitry, dedicated logic, etc.), software (such as is run on a general-purpose computer system, a dedicated machine, or a computing device of any kind (e.g., IoT node, wearable, smartphone, mobile device, etc.)), or a combination of both. The methods described herein and/or each of their individual functions (including “methods,” as used in object-oriented programming), routines, subroutines, or operations may be performed by one or more processors of a computing device (e.g., any component of FIG. 1, such as the server 106). In certain implementations, the methods described herein may be performed by a single processing thread. Alternatively, the methods described herein may be performed by two or more processing threads, wherein each thread implements one or more individual functions, routines, subroutines, or operations of the methods described herein.

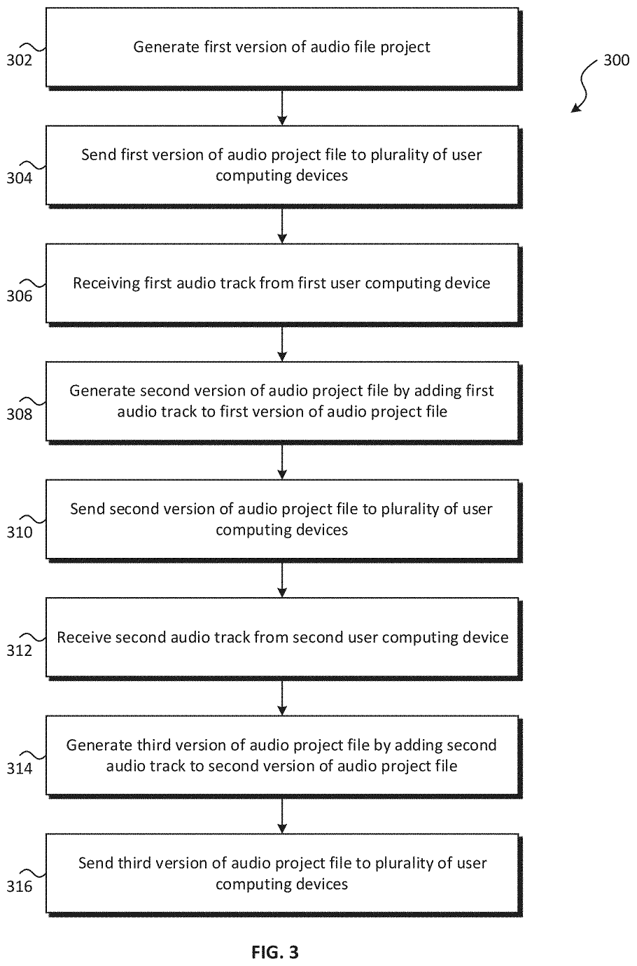

FIG. 3 is a flow diagram of an example of a method 300 for remote audio project collaboration. For simplicity of explanation, method 300 is depicted and described as a series of operations. However, operations in accordance with method 300 can occur in various orders and/or concurrently, and/or with other operations not presented and described herein. For example, the operations depicted in method 300 may occur in combination with any other operation of any other method disclosed herein. Furthermore, not all illustrated operations may be required to implement method 300 in accordance with the disclosed subject matter. In addition, those skilled in the art will understand and appreciate that method 300 could alternatively be represented via a state diagram or event diagram as a series of interrelated states.

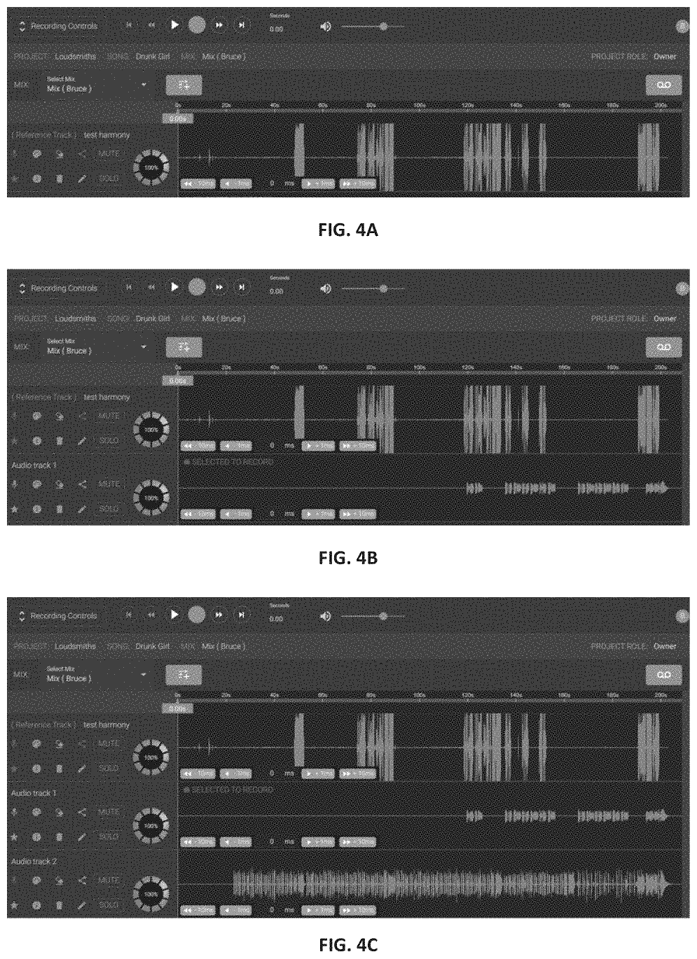

At block 302, a first version of an audio project file is generated. The first version of the audio project file includes a reference track. The reference track may include, for example, a drum line, a metronome, a harmony, an audio beat, or a combination thereof. At block 304, the first version of the audio project file is sent to a plurality of user computing devices. For example, with reference to FIG. 1, the server 106 may send the first version of the audio project file to the first user computing device 102 and the second user computer device 104 via the communications network 110. As described above, the second user computing device 104 is remotely located from the first user computing device 102. FIG. 4A is a screen shot of an example of a graphical user interface (GUI) for editing the first version of the audio project file. The GUI illustrated in FIG. 4A may be displayed on displays included in a user computing device (e.g., the first user computing device 102 and the second user computing device 104). The GUI illustrated in FIG. 4A includes the reference track.

Returning to FIG. 3, at block 306, a first audio track is received from the first user computing device 102. In some implementations, the user computing devices use a web audio application programming interface (API) to record audio tracks. Alternatively, or in addition, the user computing devices use a plugin to a digital audio workstation (DAW) to record audio tracks. The first audio track is synced to the reference track as will be described in more detail below. At block 308, a second version of the audio project file is generated by adding the first audio track to the first version of the audio project file. At block 310, the second version of the audio project file is sent to the plurality of user computing devices. FIG. 4B is a screen shot of an example of a GUI for editing the second version of the audio project file. The GUI illustrated in FIG. 4B includes the reference track and the first audio track.

Returning to FIG. 3, at block 312, a second audio track is received from the second user computing device 104. The second audio track is synced to the reference track as will be described in more detail below. At block 314, a third version of the audio project file is generated by adding the second audio track to the second version of the audio project file. At block 314, the third version of the audio project file is sent to the plurality of user computing devices. FIG. 4C is a screen shot of an example of a GUI for editing the third version of the audio project file. The GUI illustrated in FIG. 4C includes the reference track, the first audio track, and the second audio track.

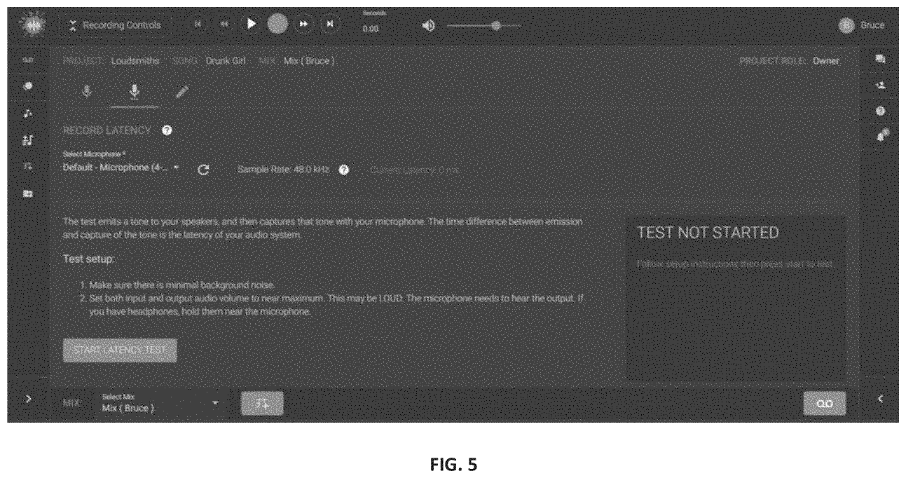

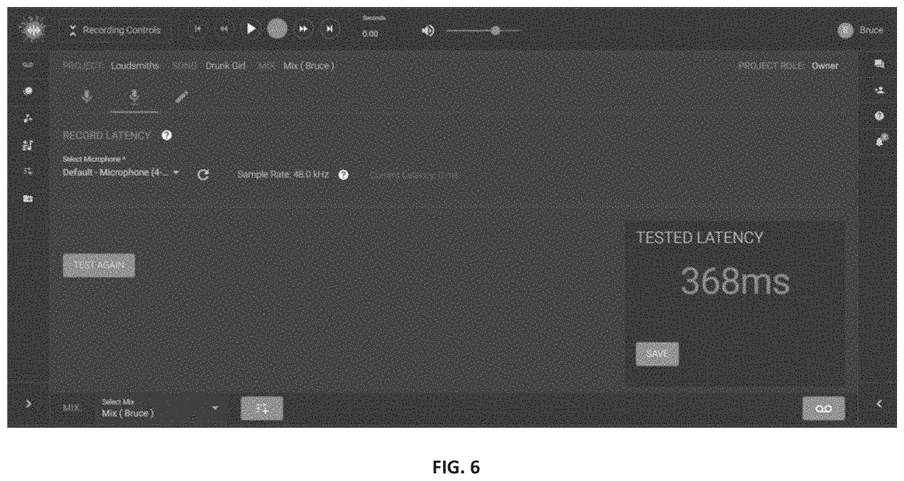

When using a web audio API to record an audio track, a user computing device may determine a system latency and adjust a time offset of the audio track relative to the reference track based on the system latency. In some implementations, a user computing device performs a latency test by emitting an audio tone via a speaker and recording the audio tone via a microphone. For example, the first user computing device 102 may emit an audio tone with the speaker 114 and record the audio tone with the microphone 112. The user computing device then measures a total input travel time of the audio tone from the microphone to the web audio API. Further, the user computing device measures a total output travel time of the audio tone from the web audio API to the speaker. Finally, the system latency may be determined based on a difference between the total input travel time and the total output travel time. In some implementations, user computing devices will display an option to perform a latency test. FIG. 5 is a screen shot of an example of a GUI for performing a latency test. FIG. 6 is a screen shot of an example of the GUI after the latency test has been performed. In some implementations, user computing devices automatically apply the measured latency to audio tracks. Alternatively, or in addition, user can apply the measured latency to individual audio tracks. For example, as illustrated in FIG. 4C, the reference track and each audio track include controls for manually adjusting latency.

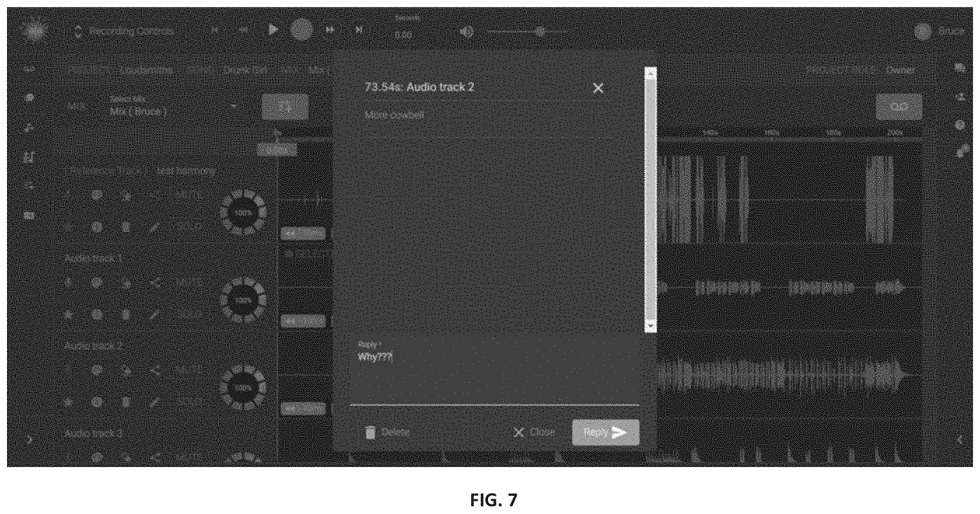

Each audio track includes a plurality of metadata. Metadata includes, for example, audio levels, track names, and display colors. In some implementations, users can adjust metadata associated with audio tracks generated by other users. For example, the server 106 may receive, from the first user computing device 102, a change to a piece of metadata associated with an audio track from the second user computing device 104 and generate a new version of the audio project file by adjusting the audio track to conform with the change of the piece of metadata. Then, the new version of the audio project file is sent to the plurality of user computing devices. User can, for example, mute audio tracks, adjust the display color of audio tracks, and add labels to audio tracks. In addition, in some implementations, users can add annotations to audio tracks. For example, users can add annotations to an audio track. As a further example, annotations on an audio track can work as chat messages between different users. FIG. 7 is a screen shot of an example of an annotation added to an audio track. The annotation illustrated in FIG. 7 includes chat messages between different users. If the users speak different languages, the system 100 may translate messages into other languages. In addition, the user has options to synchronize audio tracks among other audio tracks and change the parameters of audio tracks.

Consistent with the above disclosure, the examples of systems and methods enumerated in the following clauses are specifically contemplated and are intended as a non-limiting set of examples.

Clause 1. A method for remote audio project collaboration, the method comprising:

generating a first version of an audio project file, wherein the first version of the audio project file includes a reference track;

sending the first version of the audio project file to a plurality of user computing devices;

receiving a first audio track from a first user computing device included in the plurality of user computing devices, wherein the first audio track is synced to the reference track;

generating a second version of the audio project file by adding the first audio track to the first version of the audio project file;

sending the second version of the audio project file to the plurality of computing devices;

receiving a second audio track from a second user computing device included in the plurality of user computing devices, wherein the second audio track is synced to the reference track, and wherein the second user computing device is remotely located from the first user computing device;

generating a third version of the audio project file by adding the second audio track to the second version of the audio project file; and sending the third version of the audio project file to the plurality of computing devices.

Clause 2. The method of any clause herein, wherein the reference track includes at least one selected from the group consisting of a drum line, a metronome, a harmony, and an audio beat.

Clause 3. The method of any clause herein, further comprising:

receiving, from the first user computing device, a change to a piece of metadata associated with the second audio track;

generating a fourth version of the audio project file by adjusting the second audio track to conform with the change of the piece of metadata; and

sending the fourth version of the audio project file to the plurality of computing devices.

Clause 4. The method of any clause herein, wherein the piece of metadata includes an annotation associated with the second audio track.

Clause 5. The method of any clause herein, further comprising:

recording the first audio track on the first user computing device using a web audio application programming interface (API);

determining a system latency of the first user computing device; and

adjusting a time offset of the first audio track relative to the reference track based on the system latency of the first user computing device.

Clause 6. The method of any clause herein, wherein determining the system latency of the first user computing device further includes:

emitting an audio tone via a speaker included in the first user computing device, recording the audio tone via a microphone included in the first user computing device, measuring a total input travel time of the audio tone from the microphone to the web audio API,

measuring a total output travel time of the audio tone from the web audio API to the speaker, and

determining the system latency based on a difference between the total input travel time and the total output travel time.

Clause 7. The method of any clause herein, further comprising:

recording the first audio track on the first user computing device using a plugin to a digital audio workstation.

Clause 8. A system for remote audio project collaboration, the system comprising:

a plurality of user computing devices including at least a first user computer device and a second user computing device, wherein the second user computing device is remotely located from the first user computing device; and

a server configured to:
generate a first version of an audio project file, wherein the first version of the audio project file includes a reference track,
send the first version of the audio project file to the plurality of user computing devices,
receive a first audio track from the first user computing device, wherein the first audio track is synced to the reference track,
generate a second version of the audio project file by adding the first audio track to the first version of the audio project file,
send the second version of the audio project file to the plurality of user computing devices,
receive a second audio track from the second user computing device, wherein the second audio track is synced to the reference track,
generate a third version of the audio project file by adding the second audio track to the second version of the audio project file, and
send the third version of the audio project file to the plurality of user computing devices.

Clause 9. The system of any clause herein, wherein the reference track includes at least one selected from the group consisting of a drum line, a metronome, a harmony, and an audio beat.

Clause 10. The system of any clause herein, wherein the server is further configured to:

receive, from the first user computing device, a change to a piece of metadata associated with the second audio track,

generate a fourth version of the audio project file by adjusting the second audio track to conform with the change of the piece of metadata, and send the fourth version of the audio project file to the plurality of user computing devices.

Clause 11. The system of any clause herein, wherein the piece of metadata includes an annotation associated with the second audio track.

Clause 12. The system of any clause herein, wherein the first user computing device is further configured to:

record the first audio track using a web audio application programming interface (API), determine a system latency of the first user computing device, and

adjust a time offset of the first audio track relative to the reference track based on the system latency of the first user computing device.

Clause 13. The system of any clause herein, wherein, to determine the system latency of the first user computing device, the first user computing device is further configured to:

emit an audio tone via a speaker included in the first user computer device, record the audio tone via a microphone included in the first user computer device,

measure a total input travel time of the audio tone from the microphone to the web audio API,

measure a total output travel time of the audio tone from the web audio API to the speaker, and

determine the system latency based on a difference between the total input travel time and the total output travel time.

Clause 14. The system of any clause herein, wherein the first user computing device is further configured to record the first audio track using a plugin to a digital audio workstation.

Clause 15. The system of any clause herein, wherein the server is further configured to communicate with the plurality of user computing devices via one or more live websocket connections.

Clause 16. A tangible, non-transitory computer-readable medium storing instructions that, when executed, cause a processing device to:

generate a first version of an audio project file, wherein the first version of the audio project file includes a reference track;

send the first version of the audio project file to a plurality of user computing devices;

receive a first audio track from a first user computing device included in the plurality of user computing devices, wherein the first audio track is synced to the reference track;

generate a second version of the audio project file by adding the first audio track to the first version of the audio project file;

send the second version of the audio project file to the plurality of user computing devices;

receive a second audio track from a second user computing device included in the plurality of user computing devices, wherein the second audio track is synced to the reference track, and wherein the second user computing device is remotely located from the first user computing device;

generate a third version of the audio project file by adding the second audio track to the second version of the audio project file; and send the third version of the audio project file to the plurality of user computing devices.

Clause 17. The non-transitory computer-readable medium of any clause herein, wherein the instructions further cause the processing device to:

receive, from the first user computing device, a change to a piece of metadata associated with the second audio track;

generate a fourth version of the audio project file by adjusting the second audio track to conform with the change of the piece of metadata; and

send the fourth version of the audio project file to the first user computing device and the second user computing device.

Clause 18. The non-transitory computer-readable medium of any clause herein, wherein the piece of metadata includes an annotation associated with the second audio track.

Clause 19. The non-transitory computer-readable medium of any clause herein, wherein the instructions further cause the processing device to:

record the first audio track on the first user computing device using a web audio application programming interface (API);

determine a system latency of the first user computing device; and

adjust a time offset of the first audio track relative to the reference track based on the system latency of the first user computing device.

Clause 20. The non-transitory computer-readable medium of any clause herein, wherein, to determine the system latency of the first user computing device, the instructions further cause the processing device to:

emit an audio tone via a speaker included in the first user computing device, record the audio tone via a microphone included in the first user computing device, measure a total input travel time of the audio tone from the microphone to the web audio API,

measure a total output travel time of the audio tone from the web audio API to the speaker, and

determine the system latency based on a difference between the total input travel time and the total output travel time.

No part of the description in this application should be read as implying that any particular element, step, or function is an essential element that must be included in the claim scope. The scope of patented subject matter is defined only by the claims. Moreover, none of the claims is intended to invoke 25 U.S.C. § 104(f) unless the exact words “means for” are followed by a participle.

The foregoing description, for purposes of explanation, use specific nomenclature to provide a thorough understanding of the described embodiments. However, it should be apparent to one skilled in the art that the specific details are not required to practice the described embodiments. Thus, the foregoing descriptions of specific embodiments are presented for purposes of illustration and description. They are not intended to be exhaustive or to limit the described embodiments to the precise forms disclosed. It should be apparent to one of ordinary skill in the art that many modifications and variations are possible in view of the above teachings.

The above discussion is meant to be illustrative of the principles and various embodiments of the present disclosure. Once the above disclosure is fully appreciated, numerous variations and modifications will become apparent to those skilled in the art. It is intended that the following claims be interpreted to embrace all such variations and modifications.

What is claimed is:

1. A method for remote audio project collaboration, the method comprising:
generating a first version of an audio project file, wherein the first version of the audio project file includes a reference track;
sending the first version of the audio project file to a plurality of user computing devices;
receiving a first audio track from a first user computing device included in the plurality of user computing devices, wherein the first audio track is synced to the reference track;
generating a second version of the audio project file by adding the first audio track to the first version of the audio project file;
sending the second version of the audio project file to the plurality of computing devices;
receiving a second audio track from a second user computing device included in the plurality of user computing devices, wherein the second audio track is synced to the reference track, and wherein the second user computing device is remotely located from the first user computing device;
generating a third version of the audio project file by adding the second audio track to the second version of the audio project file; and
sending the third version of the audio project file to the plurality of computing devices.

2. The method of claim 1, wherein the reference track includes at least one selected from the group consisting of a drum line, a metronome, a harmony, and an audio beat.

3. The method of claim 1, further comprising:
receiving, from the first user computing device, a change to a piece of metadata associated with the second audio track;
generating a fourth version of the audio project file by adjusting the second audio track to conform with the change of the piece of metadata; and
sending the fourth version of the audio project file to the plurality of computing devices.

4. The method of claim 3, wherein the piece of metadata includes an annotation associated with the second audio track.

5. The method of claim 1, further comprising:
recording the first audio track on the first user computing device using a web audio application programming interface (API);
determining a system latency of the first user computing device; and
adjusting a time offset of the first audio track relative to the reference track based on the system latency of the first user computing device.

6. The method of claim 5, wherein determining the system latency of the first user computing device further includes:
emitting an audio tone via a speaker included in the first user computing device,
recording the audio tone via a microphone included in the first user computing device,
measuring a total input travel time of the audio tone from the microphone to the web audio API,
measuring a total output travel time of the audio tone from the web audio API to the speaker, and
determining the system latency based on a difference between the total input travel time and the total output travel time.

7. The method of claim 1, further comprising:
recording the first audio track on the first user computing device using a plugin to a digital audio workstation.

8. A system for remote audio project collaboration, the system comprising:
a plurality of user computing devices including at least a first user computer device and a second user computing device, wherein the second user computing device is remotely located from the first user computing device; and
a server configured to:
generate a first version of an audio project file, wherein the first version of the audio project file includes a reference track,
send the first version of the audio project file to the plurality of user computing devices,
receive a first audio track from the first user computing device, wherein the first audio track is synced to the reference track,
generate a second version of the audio project file by adding the first audio track to the first version of the audio project file,
send the second version of the audio project file to the plurality of user computing devices,
receive a second audio track from the second user computing device, wherein the second audio track is synced to the reference track,
generate a third version of the audio project file by adding the second audio track to the second version of the audio project file, and
send the third version of the audio project file to the plurality of user computing devices.

9. The system of claim 8, wherein the reference track includes at least one selected from the group consisting of a drum line, a metronome, a harmony, and an audio beat.

10. The system of claim 9, wherein the server is further configured to:
receive, from the first user computing device, a change to a piece of metadata associated with the second audio track,
generate a fourth version of the audio project file by adjusting the second audio track to conform with the change of the piece of metadata, and
send the fourth version of the audio project file to the plurality of user computing devices.

11. The system of claim 10, wherein the piece of metadata includes an annotation associated with the second audio track.

12. The system of claim 8, wherein the first user computing device is further configured to:
record the first audio track using a web audio application programming interface (API), determine a system latency of the first user computing device, and
adjust a time offset of the first audio track relative to the reference track based on the system latency of the first user computing device.

13. The system of claim 12, wherein, to determine the system latency of the first user computing device, the first user computing device is further configured to:
emit an audio tone via a speaker included in the first user computer device, record the audio tone via a microphone included in the first user computer device, measure a total input travel time of the audio tone from the microphone to the web audio API,
measure a total output travel time of the audio tone from the web audio API to the speaker, and
determine the system latency based on a difference between the total input travel time and the total output travel time.

14. The system of claim 8, wherein the first user computing device is further configured to record the first audio track using a plugin to a digital audio workstation.

15. The system of claim 8, wherein the server is further configured to communicate with the plurality of user computing devices via one or more live websocket connections.

16. A tangible, non-transitory computer-readable medium storing instructions that, when executed, cause a processing device to:
generate a first version of an audio project file, wherein the first version of the audio project file includes a reference track;
send the first version of the audio project file to a plurality of user computing devices;
receive a first audio track from a first user computing device included in the plurality of user computing devices, wherein the first audio track is synced to the reference track;
generate a second version of the audio project file by adding the first audio track to the first version of the audio project file;
send the second version of the audio project file to the plurality of user computing devices;
receive a second audio track from a second user computing device included in the plurality of user computing devices, wherein the second audio track is synced to the reference track, and wherein the second user computing device is remotely located from the first user computing device;
generate a third version of the audio project file by adding the second audio track to the second version of the audio project file; and
send the third version of the audio project file to the plurality of user computing devices.

17. The non-transitory computer-readable medium of claim 16, wherein the instructions further cause the processing device to:
receive, from the first user computing device, a change to a piece of metadata associated with the second audio track;
generate a fourth version of the audio project file by adjusting the second audio track to conform with the change of the piece of metadata; and
send the fourth version of the audio project file to the first user computing device and the second user computing device.

18. The non-transitory computer-readable medium of claim 17, wherein the piece of metadata includes an annotation associated with the second audio track.

19. The non-transitory computer-readable medium of claim 16, wherein the instructions further cause the processing device to:
record the first audio track on the first user computing device using a web audio application programming interface (API);
determine a system latency of the first user computing device; and
adjust a time offset of the first audio track relative to the reference track based on the system latency of the first user computing device.

20. The non-transitory computer-readable medium of claim 19, wherein, to determine the system latency of the first user computing device, the instructions further cause the processing device to:
emit an audio tone via a speaker included in the first user computing device, record the audio tone via a microphone included in the first user computing device, measure a total input travel time of the audio tone from the microphone to the web audio API,
measure a total output travel time of the audio tone from the web audio API to the speaker, and
determine the system latency based on a difference between the total input travel time and the total output travel time.
